(19) United States
(12) Patent Application Publication
(10) Pub. No.: US 2024/0274891 A1
(43) Pub. Date: Aug. 15, 2024

(54) ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si, Gyeonggi-do (KR)

(72) Inventors: Hoyong AN, Yongin-si (KR); Suhyun KIM, Yongin-si (KR); Hyunhee KIM, Yongin-si (KR)

(21) Appl. No.: 18/362,709

(22) Filed: Jul. 31, 2023

(30) Foreign Application Priority Data
Feb. 6, 2023 (KR) 10-2023-0015564

(51) Int. Cl. H01M 10/42; H01M 4/131; H01M 4/58; H01M 4/62

(52) U.S. Cl. CPC H01M 10/4235; H01M 4/131; H01M 4/5825; H01M 4/623; H01M 2004/021

(57) ABSTRACT

An electrode for a rechargeable lithium battery and a rechargeable lithium battery including the same are provided. An electrode for a rechargeable lithium battery includes a current collector; an active material layer on the current collector; and a functional layer between the current collector and the active material layer, wherein the functional layer includes a first functional layer and a second functional layer, the first functional layer includes a positive temperature coefficient (PTC) resin, and the second functional layer includes a lithium transition metal phosphate.

### CROSS-REFERENCE TO RELATED APPLICATION

This application claims priority to and the benefit of Korean Patent Application No. 10-2023-0015564, filed in the Korean Intellectual Property Office on Feb. 6, 2023, the entire content of which is herein incorporated by reference.

### BACKGROUND

### 1. Field

Embodiments of the present disclosure relate to an electrode for a rechargeable lithium battery and a rechargeable lithium battery including the same.

### 2. Description of the Related Art

Portable information devices, such as cell phones, laptops, smart phones, and/or the like and/or electric vehicles have utilized rechargeable lithium batteries having high energy densities and easy portability as driving power sources. A rechargeable lithium battery usually has a structure including a positive electrode, a negative electrode, and a separator disposed therebetween. In addition, the positive electrode and the negative electrode respectively may include a current collector and an active material layer formed on the current collector.

Recently, research on utilizing the rechargeable lithium batteries with high energy densities as power sources for driving hybrid vehicles and/or battery-powered vehicles and/or for storing electric power has been being actively made or research, and in this regard, there is a high interest in preventing or reducing overcharging and/or overheating and securing safety against physical impacts (e.g., damages) during the operations of the rechargeable lithium batteries.

### SUMMARY

One or more embodiments of the present disclosure are directed toward an electrode for a rechargeable lithium battery capable of ensuring physical and thermal safety as well as electrochemical safety of the rechargeable lithium battery and minimizing or reducing energy density reduction.

In one or more embodiments, an electrode for a rechargeable lithium battery includes a current collector; an active material layer on the current collector; and a functional layer between the current collector and the active material layer, wherein the functional layer includes a first functional layer and a second functional layer, and the first functional layer includes a positive temperature coefficient (PTC) resin, and the second functional layer includes a lithium transition metal phosphate.

One or more embodiments provide a rechargeable lithium battery including the electrode and the electrolyte.

In the rechargeable lithium battery including the electrode for a rechargeable lithium battery according to one or more embodiments, physical and thermal safety as well as electrochemical safety may be secured or improved, and energy density reduction may be minimized or reduced.

### BRIEF DESCRIPTION OF THE DRAWINGS

FIGS. 1 and 2 are each a schematic view showing an electrode for a rechargeable lithium battery according to one or more embodiments of the present disclosure.

FIG. 3 is a schematic view illustrating a rechargeable lithium battery according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure. The embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

The terminology used herein is used to describe particular embodiments only and is not intended to limit the present disclosure. As used herein, the singular forms “a,” “an” and “the” are intended to include the plural forms as well, unless the context clearly indicates otherwise.

The term “combination thereof” means a mixture, laminate, composite, copolymer, alloy, blend, reaction product, and/or the like of the constituents.

It should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness or relative size of layers, films, panels, regions, etc., may be exaggerated for clarity and like reference numerals designate like elements throughout, and duplicative descriptions thereof may not be provided the specification. It will be understood that when an element such as a layer, film, region, or substrate is referred to as being “on” or “connected to” another element, it can be directly on or connected to the other element or intervening elements may also be present. In contrast, when an element is referred to as being “directly on” another element, there are no intervening elements present. In addition, it will also be understood that when an element or layer is referred to as being “between” two elements or layers, it can be the only element or layer between the two elements or layers, or one or more intervening elements or layers may also be present.

“Layer” herein includes not only a shape formed on the whole surface when viewed from a plan view, but also a shape formed on a partial surface.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

As used herein, the term “and/or” includes any and all combinations of one or more of the associated listed items.

Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

In the present disclosure, when particles are spherical, “diameter” indicates a particle diameter or an average particle diameter, and when the particles are non-spherical, the “diameter” indicates a major axis length or an average major axis length. “Particle diameter” or “average particle diameter” may be measured by a method generally available to those skilled in the art, for example, may be measured by a particle size analyzer, or may be measured by a transmission electron micrograph or a scanning electron micrograph. In one or more embodiments, it is possible to obtain an average particle diameter value by measuring utilizing a dynamic light scattering method, performing data analysis, counting the number of particles for each particle size range, and calculating from this. Unless otherwise defined, the average particle diameter may refer to a diameter (D50) of particles having a cumulative volume of 50 volume % in the particle size distribution.

“Thickness” may be measured through an image taken with an optical microscope such as a scanning electron microscope.

### Electrode

In one or more embodiments, an electrode for a rechargeable lithium battery includes a current collector; an active material layer on the current collector; and a functional layer between the current collector and the active material layer, wherein the functional layer includes a first functional layer and a second functional layer, the first functional layer includes a positive temperature coefficient (PTC) resin, and the second functional layer includes a lithium transition metal phosphate.

Because the lithium transition metal phosphate is a low exothermic material, when a short circuit occurs due to overcharging in a rechargeable lithium battery including the electrode of one or more embodiments, as a current does not flow directly to the current collector but flows to an active material ↔the second functional layer↔the current collector, the lithium transition metal phosphate induces reduction of Joule heat. Accordingly, when a short circuit occurs due to the overcharging in the rechargeable lithium battery including the electrode of one or more embodiments, an overall exothermic amount is reduced, securing safety and reliability.

However, when the second functional layer including the lithium transition metal phosphate alone is introduced into the electrode, it is difficult to respond to (or counter against) physical and thermal issues as well as electrochemical issues due to the overcharging. In this regard, in the electrode of one or more embodiments, the first functional layer including the positive temperature coefficient resin in addition to the second functional layer including the lithium transition metal phosphate is introduced.

The “positive temperature coefficient resin” has relatively low resistance at room temperature and passes the current well, but when exposed to a temperature environment of greater than or equal to about 100° C. and for example, greater than or equal to about 110° C., exhibits sharply increased resistance about 1,000 times or higher than its normal state. According to Ohm's law, when the current is constant, a voltage increases in proportion to an increase in resistance. Accordingly, when the rechargeable lithium battery including the electrode of one or more embodiments reaches an abnormal temperature (about 100° C. or higher, for example, about 110° C. or higher) due to internal exothermicity by the overcharging and/or the like, the first functional layer including the positive temperature coefficient resin may limit movement of lithium ions and electrons, while increasing internal resistance of the rechargeable lithium battery, thereby shutting down the rechargeable lithium battery.

Furthermore, the positive temperature coefficient resin has high tensile strength and may enhance safety against physical impacts such as penetration, crushing, bending, etc., which are applied from the outside of the rechargeable lithium battery including the electrode of one or more embodiments.

In brief, the rechargeable lithium battery including the electrode of one or more embodiments may secure electrochemical (for example, overcharge) safety through the second functional layer including the lithium transition metal phosphate and also, physical and thermal safety through the first functional layer including the positive temperature coefficient resin, resulting in minimizing or reducing energy density reduction when issues occur.

Hereinafter, elements constituting an electrode of one or more embodiments are described in more detail.

### Structure of Functional Layer

As described above, the functional layer includes a first functional layer and a second functional layer, the first functional layer includes a positive temperature coefficient resin, and the second functional layer includes a lithium transition metal phosphate.

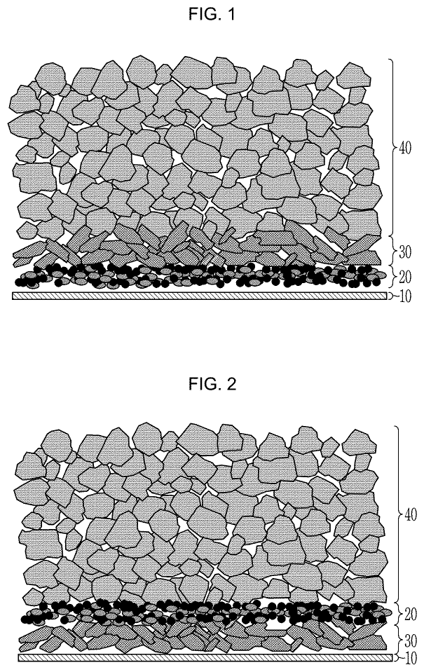

A stacking order of the first functional layer and the second functional layer is not limited. FIGS. 1 and 2 are each a schematic view showing an electrode for a rechargeable lithium battery according to one or more embodiments. As shown in FIG. 1, the first functional layer 20 may contact the current collector 10 while the second functional layer 30 may contact the active material layer 40. In one or more embodiments, as shown in FIG. 2, the first functional layer 20 may contact the active material layer 40 while the second functional layer 30 may contact the current collector 10.

Both of the cases are appropriate or suitable. The case of FIG. 1 may appropriately respond to one or more suitable issues occurring in rechargeable lithium batteries. For example, the case of contact the first functional layer with the current collector, compared with the other case of contacting the first functional layer with an active material, may induce the current on the current collector to flow from the active material layer ↔the first functional layer ↔the second functional layer↔the current collector and thus reduce Joule heat. In one or more embodiments, the first functional layer may also have an effect of adhering the active material layer to the current collector. Simultaneously, when the second functional layer is in contact with the active material, compared with when the second functional layer is in contact with the current collector, the former may better respond to external physical impacts or fire applied to the rechargeable lithium batteries, internal exothermicity due to a short circuit between the active material layer and the separator during the overcharging, and/or the like.

A thickness ratio of the first functional layer and the second functional layer may be about 1:10 to about 10:1, for example, about 3:5 to about 5:5. Within these ranges, the first functional layer and the second functional layer are harmonized or substantially harmonized, so that electrochemical, physical, and thermal safety may be evenly or substantially secured.

On the other hand, a thickness ratio of an entire functional layer composed of the first functional layer and the second functional layer; and the active material layer may be about 1:5 to about 1:100, about 1:10 to about 1:50, or about 1:10 to about 1:20. Within these ranges, functions of the entire functional layer and the active material layer are harmonized or substantially harmonized, so that electrochemical, physical, and thermal safety can be secured or improved by the entire functional layer, while capacity can be secured or improved by the active material layer.

For example, a thickness of the first functional layer may be about 0.5 μm to about 10 μm, about 1 μm to about 10 μm, or about 1 μm to about 5 μm. In one or more embodiments, a thickness of the second functional layer may be about 0.5 μm to about 10 μm, about 1 μm to about 10 μm, or about 1 μm to about 5 μm. In one or more embodiments, a thickness of the active material layer may be about 10 μm to about 200 μm, about 20 μm to about 150 μm, or about 50 μm to about 130 μm.

### First Functional Layer

The first functional layer includes the positive temperature coefficient resin, thereby ensuring physical and thermal safety of the rechargeable lithium battery. The positive temperature coefficient resin may be a polymer resin that expands in a temperature range of about 90° C. to about 200° C., for example, about 100° C. to about 150° C., or about 100° C. to about 120° C. so that so that a shutdown function may be exhibited when the rechargeable lithium battery reaches an abnormal temperature (about 60° C. or greater, or for example, about 80° C. or greater).

Because such a polymer resin expands near a melting temperature (Tm), a crystalline polyolefin resin having a melting point of about 100° C. to about 150° C. may be utilized. For example, the positive temperature coefficient resin may include high density polyethylene (HDPE), polypropylene (PP), low density polyethylene (LDPE), polystyrene (PS), polytetrafluoroethylene (PTFE), polyvinyl chloride (PVC), or a combination thereof. Table 1 shows a density and a melting point of the example positive temperature coefficient resins. For reference, the density may be measured in an ASTM D1238 method, and the melting point is measured in an ASTM D2117 method.

TABLE 1

| | Density (g/cm³): measured | Melting point (° C.): measured |
|---|---|---|
| | value according to ASTM | value by ASTM D2117 |
| | D1238 measurement method | measurement method |
| HDPE | 0.941 to 0.965 | 130 |
| PP | 0.89 to 0.91 | 150 |
| LDPE | 0.910 to 0.925 | 105 |
| PS | 1.04 to 1.07 | 105 |
| PTFE | 2.14 to 2.21 | 330 (Tg 130° C.) |
| PVC | 1.16 to 1.3 | 90 |

For example, low density polyethylene utilized as the positive temperature coefficient resin is a polymer with high tensile strength and expands at about 105° C. Accordingly, the low density polyethylene, which is utilized as the positive temperature coefficient resin, may harmoniously secure physical and thermal safety of a rechargeable lithium battery, but both of them may be utilized alone. The positive temperature coefficient resin may have a weight average molecular weight of about 5,000 g/mol to about 200,000 g/mol and a D50 particle diameter of about 0.5 μm to about 5 μm.

The first functional layer includes the positive temperature coefficient resin and may further include a first conductive material, a first binder, or a combination thereof. For example, the first functional layer may include aggregates of the positive temperature coefficient resin and the first conductive material under the presence of the first binder.

When the positive temperature coefficient resin thermally expands around a fusion region, the aggregates of the positive temperature coefficient resin, the first conductive material, and the first binder may become apart from one another (e.g., may melt together) and destroy or reduce a conductive network of the first conductive material, hindering tunneling of electrons and thereby, rapidly increasing electrical resistance. This phenomenon itself may also be referred to as a positive temperature coefficient (PTC) phenomenon.

On the other hand, when the positive temperature coefficient resin is fused and thermally expands, as a dispersion state of the first conductive material changes, a new conductive network may be formed, thereby (result in the form of) greatly or substantially reducing (e.g., reducing the increase of) the resistance. This phenomenon may be referred to as a negative temperature coefficient (NTC) phenomenon.

The first conductive material may include, for example, a carbon material, a metal material, a metal carbide, a metal nitride, a metal silicide, or a combination thereof. The carbon material may include carbon black, graphite, a carbon fiber, carbon nanotube (CNT), L-carbon nanotube (long length CNT), or a combination thereof. The carbon black may be, for example, acetylene black, ketjen black, channel black, furnace black, lamp black, thermal black, or a combination thereof and the graphite may include natural graphite, artificial graphite, or a combination thereof. The metal material may be a metal particle or a metal fiber of nickel. The metal carbide may include, for example, WC, B₄C, ZrC, NbC, MOC, TIC, TaC, or a combination thereof, the metal nitride may include TIN, ZrN, TaN, or a combination thereof, and the metal silicide may include, for example, WSi₂, MoSi₂, or a combination thereof. A D50 particle diameter of the first conductive material may be about 1 nm to about 100 nm, or about 5 nm to about 50 nm.

The first binder may play a role of attaching (securely attaching) materials in the first functional layer to each other and adhering (securely adhering) the functional layer to the active material layer. The first binder may be a non-water-soluble binder, a water-soluble binder, or a combination thereof. For example, the first binder may be a non-water-soluble binder and may include a polyvinylidene fluoride-based binder, a polyamide-based binder, or a combination thereof. For example, the polyvinylidene fluoride-based binder may include polyvinylidene fluoride, polyvinylidene fluoride-co-hexafluoropropylene, polyvinylidene fluoride-co-trichloroethylene, polyvinylidene fluoride— including co-tetrafluoroethylene, polyvinylidene fluoride-co-trifluoroethylene, polyvinylidene fluoride-co-trifluorochloroethylene, polyvinylidene fluoride-co-ethylene, or a combination thereof. In one or more embodiments, the polyamide-based binder may include polyamide, polyamideimide, or a combination thereof. For example, when LDPE is utilized, when the rechargeable lithium battery including the electrode of one or more embodiments reaches a temperature (about 100° C. or higher and for example, about 110° C. or higher), the LDPE may expand and block or reduce the current.

Based on 100 wt % of the total amount of the first functional layer, the positive temperature coefficient resin may be included in an amount of about 5 wt % to about 80 wt %, or about 20 wt % to about 60 wt %; the first conductive material may be included in an amount of about 0.5 wt % to about 50 wt %, or about 10 wt % to about 50 wt %, and the first binder may be included in an amount of about 0.5 wt % to about 50 wt %, or about 1 wt % to about 20 wt %. Within these ranges, the positive temperature coefficient resin and the first conductive material may form aggregates at a suitable aggregation degree due to the first binder, and the aggregates may harmonize the positive temperature coefficient phenomenon and the negative temperature coefficient phenomenon.

### Second Functional Layer

The second functional layer includes the lithium transition metal phosphate, through which it secures electrochemical safety of a rechargeable lithium battery. The lithium transition metal phosphate may be a material with an olivine-based crystal structure capable of not only inducing reduction of Joule heat and increasing capacity or an output but also expressing capacity as an active material.

For example, it may include a compound represented by Chemical Formula 1, a compound represented by Chemical Formula 2, or a combination thereof.

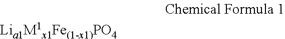

In Chemical Formula 1, 0.90≤a1≤1.5, 0≤x1≤0.4, and M¹ is Mg, Co, Ni or a combination thereof.

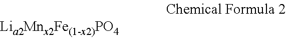

In Chemical Formula 2, 0.90≤a2≤1.5, and 0.1≤x2≤1.

The compound represented by Chemical Formula 1 may be a lithium iron phosphate compound. A mole fraction of lithium in Chemical Formula 1 may be appropriately adjusted between approximately (about) 0.9 and (about) 1.5, and may be, for example, 0.90≤a1≤1.2 or 0.95≤a1≤1.1. In Chemical Formula 1, Mn may be present in addition to Fe, and a mole fraction thereof may be 0≤x1≤0.7, 0≤x1≤0.5, 0≤x1≤0.3, 0≤x1≤0.1, or 0≤x1≤0.05.

The compound represented by Chemical Formula 2 may be a lithium manganese iron compound (lithium manganese iron phosphate). In Chemical Formula 2, a mole fraction of lithium in Chemical Formula 2 may be 0.90≤a2≤1.2 or 0.95≤a2≤1.1. In Chemical Formula 2, a mole fraction of manganese may be 0.2≤x2≤0.9, 0.3≤x2≤0.9, or 0.4≤x2≤0.8, and for example, when 0.5≤x2≤0.9, lithium ion conductivity is high. For example, the second functional layer may include LiFePO₄, LiMn_{0.5}Fe_{0.5}PO₄, LiMnPO₄, and/or the like as the lithium transition metal phosphate.

A D50 particle size of the lithium transition metal phosphate may be greater than 0 μm, greater than or equal to about 0.3 μm, and less than or equal to about 5 μm, less than or equal to about 3 μm, or less than or equal to about 1 μm.

The second functional layer may further include a second conductive material, a second binder, or a combination thereof while including the lithium transition metal phosphate.

The second conductive material may form a conductive network connected to the active material layer via the current collector and the first functional layer. The second conductive material may include, for example, a carbon material, a metal material, a metal carbide, a metal nitride, a metal silicide, or a combination thereof. The carbon material may include carbon black, graphite, a carbon fiber, carbon nanotube (CNT), L-carbon nanotube (long length CNT), or a combination thereof. The carbon black may be, for example, acetylene black, ketjen black, channel black, furnace black, lamp black, thermal black, or a combination thereof and the graphite may include natural graphite, artificial graphite, or a combination thereof. The metal material may be a metal particle or a metal fiber of nickel. The metal carbide may include, for example, WC, B₄C, ZrC, NbC, MOC, TiC, TaC, or a combination thereof, the metal nitride may include TIN, ZrN, TaN, or a combination thereof, and the metal silicide may include, for example, WSi₂, MoSi₂, or a combination thereof. A D50 particle diameter of the second conductive material may be about 1 nm to about 100 nm, or about 5 nm to about 50 nm.

The second binder may play a role of attaching (securely attaching) materials in the second functional layer to each other and adhering (securely adhering) the functional layer to the active material layer. The second binder may be a water-insoluble binder, a water-soluble binder, or a combination thereof. For example, the second binder may include a polyvinyl chloride-based binder as a water-insoluble binder. The polyvinyl chloride-based binder may be, for example, polyvinyl chloride.

Based on 100 wt % of the total amount of the first functional layer, the transition metal phosphate may be included in an amount of about 50 wt % to about 99 wt %, or about 80 wt % to about 97 wt %; the second conductive material may be included in an amount of about 0.5 wt % to about 10 wt %, or about 1 wt % to about 7 wt %, and the second binder may be included in an amount of about 0.5 wt % to about 20 wt %, or about 1 wt % to about 10 wt %. Within these ranges, each function of the transition metal phosphate, the second conductive material, and the second binder may be harmonized or substantially harmonized.

### Active Material Layer

The electrode may be a positive electrode, and the active material layer may be a positive active material layer and may include a positive electrode active material.

The positive electrode active material may include lithiated intercalation compounds that reversibly intercalate and deintercalate lithium ions. Examples of the positive electrode active material include a compound represented by any one of the following chemical formulas: LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}CO_{b}X_{c}Dₐ (0.90≤a≤1.8, 0≤b≤0.5, 0≤c≤0.5, 0≤a≤2); LiₐNi_{1-b-c}CO_{b}X_{c}O₂₋ₐTₐ (0.90≤a≤1.8, 0 ≤b≤0.5, 0≤0.05, 0<a<2); LiₐNi_{1-b-c}CO_{b}X_{c}O₂₋ₐT₂ (0.90≤a≤1.8, 0≤b>0.5, 0≤c≤0.05, 0≤a≤2); LiₐNi_{1-b-c}Mn_{b}X_{c}Dₐ (0.90≤a≤1.8, 0≤b≤0.5, 0≤c≤0.05, 0<a≤2); LiₐNi_{1-b-c}Mn_{b}X_{c}O₂₋ₐTₐ (0.90≤a≤1.8, 0≤b≤0.5, 0≤c≤0.05, 0≤a≤2); LiₐNi_{1-b-c} Mn_{b}X_{c}O₂₋ₐT₂ (0.90≤a≤1.8, 0≤b≤0.5, 0≤c≤0.05, 0≤a≤2); LiₐNi_{b}E_{c}GₐO₂ (0.90≤a≤1.8, 0≤b≤0.9, 0≤c≤0.5, 0.001≤d≤0.1); LiₐNi_{b}Co_{c}MnₐGₑO₂ (0.90≤a≤1.8, 0≤b≤0.9, 0≤c≤0.5, 0≤d≤0.5, 0.001 e≤0.1); LiₐNiG_{b}O₂ (0.90≤a≤1.8, 0.001≤b≤0.1);LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g 1≤0.5); QO₂; QS₂; LiQS₂; V₂O₅; LiV₂O₅;LiZO₂;LiNiVO₄; Li_{(3-f)}J₂(PO₄)₃ (0≤f≤2); Li_{(3-f)} Fe_{z}(PO₄)₃ (0≤f≤2); and/or LiₐFePO₄ (0.90≤a≤1.8).

In the above chemical formulas, A may include (e.g., may be selected from) Ni, Co, Mn, and/or a combination thereof; X may include (e.g., may be selected from) Al, Ni, Co, Mn, Cr, Fe, Mg, Sr, V, a rare earth element, and/or a combination thereof; D may include (e.g., may be selected from) O, F, S, P, and/or a combination thereof; E may include (e.g., may be selected from) Co, Mn, and/or a combination thereof; T may include (e.g., may be selected from) F, S, P, and/or a combination thereof; G may include (e.g., may be selected from) Al, Cr, Mn, Fe, Mg, La, Ce, Sr, V, and/or a combination thereof; Q may include (e.g., may be selected from) Ti, Mo, Mn, and/or a combination thereof; Z may include (e.g., may be selected from) Cr, V, Fe, Sc, Y, and/or a combination thereof; and J may include (e.g., may be selected from) V, Cr, Mn, Co, Ni, Cu, and/or a combination thereof.

The compounds may have a coating layer on the surface, or may be mixed with another compound having a coating layer. The coating layer may include at least one coating element compound of (e.g., selected from) an oxide of a coating element, a hydroxide of a coating element, an oxyhydroxide of a coating element, an oxycarbonate of a coating element, and/or a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. A method of providing the coating layer may be a method that does not adversely affect physical properties of the positive electrode active material, for example, spray coating, dipping, and/or the like.

The positive electrode active material may include, for example, a lithium cobalt composite oxide represented by Chemical Formula 3.

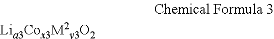

1 In Chemical Formula 3, 0.9≤a3≤1.8, 0.3≤x3≤0.98, 0.01≤y3≤0.69, and M² may include (e.g., may be selected from) Al, Mn, B, Ce, Cr, F, Mg, Mo, Nb, P, S, Si, Sr, Ti, V, W, Zr, and/or a combination thereof.

In Chemical Formula 3, 0.4≤x3≤0.98 and 0.01≤y3≤0.59; 0.5≤x3≤0.98 and 0.01≤y3≤0.49; 0.6≤x3≤0.98 and 0.01≤y3≤0.39; 0.7≤x3≤0.98 and 0.01≤y3≤0.29:0.8≤x3≤0.98 and 0.01≤y3≤0.19; or 0.9≤x3≤0.98, 0.01≤y3≤0.09.

The positive electrode active material layer may include a positive electrode active material, and may further include a third conductive material, a third binder, or a combination thereof. Here, a content (e.g., amount) of the positive electrode active material may be about 85 wt % to about 98 wt %, for example, about 90 wt % to about 95 wt % based on the total weight of the positive electrode active material layer. Contents of the third binder and the third conductive material may be about 1 wt % to about 10 wt %, for example, about 1 wt % to about 5 wt %, respectively, based on the total weight of the positive electrode active material layer.

The third binder serves to attach (securely or substantially attach) the positive electrode active material particles to each other and to attach (securely or substantially attach) the positive electrode active material to the current collector, and examples thereof may include polyvinyl alcohol, carboxymethylcellulose, hydroxypropylcellulose, diacetylcellulose, polyvinylchloride, carboxylated polyvinylchloride, polyvinylfluoride, polymers containing ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

The third conductive material is included to provide electrode conductivity and any electrically conductive material may be utilized as a conductive material unless it causes a chemical change. Examples of the conductive material include a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof.

### Current Collector

The current collector may include (e.g., may be selected from) an aluminum foil, a copper foil, a nickel foil, a stainless-steel foil, a titanium foil, a nickel foam, a copper foam, a polymer substrate coated with a conductive metal, or a combination thereof. When the electrode of one or more embodiments is a positive electrode, an aluminum foil may be utilized as the current collector, but the present disclosure is not limited thereto.

### Rechargeable Lithium Battery

In one or more embodiments, a rechargeable lithium battery includes a positive electrode, a negative electrode, and an electrolyte between the positive electrode and the positive electrode.

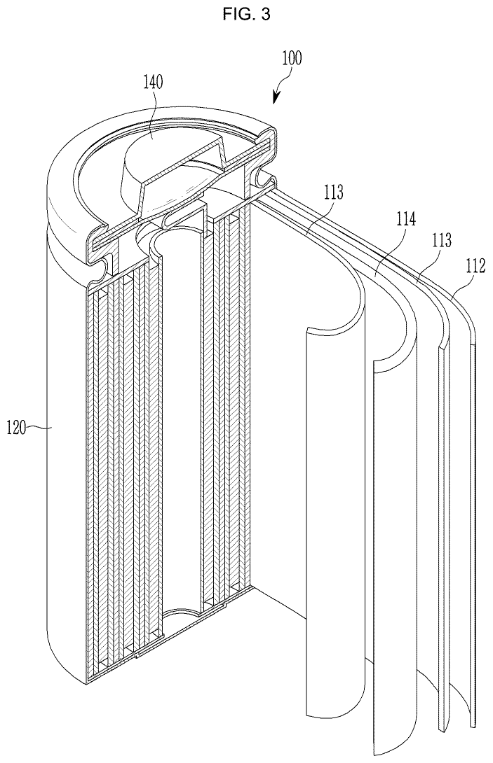

FIG. 3 is a schematic view illustrating a rechargeable lithium battery according to one or more embodiments of the present disclosure. Referring to FIG. 3, a rechargeable lithium battery 100 according to one or more embodiments includes a battery cell including a positive electrode 114, a negative electrode 112 facing the positive electrode 114, a separator 113 between the positive electrode 114 and the negative electrode 112, and an electrolyte for a rechargeable lithium battery impregnated in the positive electrode 114, negative electrode 112, and separator 113, a battery case 120 housing the battery cell, and a sealing member 140 sealing the battery case 120.

In the rechargeable lithium battery of one or more embodiments, the aforementioned electrode may be applied to the positive electrode alone, to the negative electrode alone, or applied to both the positive electrode and the negative electrode. For example, the rechargeable lithium battery of one or more embodiments may be one in which the aforementioned electrode is applied to the positive electrode alone.

Hereinafter, descriptions overlapping with those described above may be omitted, and elements constituting the rechargeable lithium battery other than the positive electrode are described in more detail.

### Negative Electrode

The negative electrode includes a current collector and a negative electrode active material layer on the current collector and including a negative electrode active material. According to one or more embodiments, the negative electrode may have a structure in which a current collector, a negative electrode active material layer, a functional layer, and an adhesive layer are sequentially stacked.

The negative electrode active material may include a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include, for example crystalline carbon, amorphous carbon, or a combination thereof as a carbon-based negative electrode active material. The crystalline carbon may be irregular, plate, flake, spherical, or fiber-shaped natural graphite or artificial graphite. The amorphous carbon may be a soft carbon, a hard carbon, a mesophase pitch carbonization product, calcined coke, and/or the like.

The lithium metal alloy may be an alloy of lithium and a metal including (e.g., selected from) Na, K, Rb, Cs, Fr, Be, Mg, Ca, Sr, Si, Sb, Pb, In, Zn, Ba, Ra, Ge, Al, and/or Sn.

The material capable of doping/dedoping lithium may be a Si-based negative electrode active material or a Sn-based negative electrode active material. The Si-based negative electrode active material may include silicon, a silicon-carbon composite, SiOₓ (0≤x<2), a Si-Q alloy, wherein Q is an alkali metal, an alkaline-earth metal, a Group 13 element, a Group 14 element, a Group 15 element, a Group 16 element, a transition metal, a rare earth element, and/or a combination thereof, but not Si, and the Sn-based negative electrode active material may include Sn, SnO₂, a Sn—R alloy, wherein R is an alkali metal, an alkaline-earth metal, a Group 13 element, a Group 14 element, a Group 15 element, a Group 16 element, a transition metal, a rare earth element, and/or a combination thereof, but not Sn. At least one of these materials may be mixed with SiO₂. The elements Q and R may include (e.g., may be selected from) Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and/or a combination thereof.

The silicon-carbon composite may be for example a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content (e.g., amount) of silicon may be about 10 wt % to about 50 wt % based on the total weight of the silicon-carbon composite. In one or more embodiments, the content (e.g., amount) of the crystalline carbon may be about 10 wt % to about 70 wt % based on the total weight of the silicon-carbon composite, and the content (e.g., amount) of the amorphous carbon may be about 20 wt % to about 40 wt % based on the total weight of the silicon-carbon composite. In one or more embodiments, a thickness of the amorphous carbon coating layer may be about 5 nm to about 100 nm. An average particle diameter (D50) of the silicon particles may be about 10 nm to about 20 μm. The average particle diameter (D50) of the silicon particles may be about 10 nm to about 200 nm. The silicon particles may exist in an oxidized form, and in this case, an atomic content (e.g., amount) ratio of Si:O in the silicon particles indicating a degree of oxidation may be a weight ratio of about 99:1 to about 33:66. The silicon particles may be SiOₓ particles, and in this case, the range of x in SiOₓ may be greater than about 0 and less than about 2. In the present disclosure, As used herein, when a definition is not otherwise provided, an average particle diameter (D50) indicates a diameter of particles having a cumulative volume of 50 volume % in the particle size distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and utilized, the mixing ratio may be a weight ratio of about 1:99 to about 90:10.

In the negative electrode active material layer, the negative electrode active material may be included in an amount of about 95 wt % to about 99 wt % based on the total weight of the negative electrode active material layer.

In one or more embodiments, the negative electrode active material layer further includes a binder, and may optionally further include a conductive material. The content (e.g., amount) of the binder in the negative electrode active material layer may be about 1 wt % to about 5 wt % based on the total weight of the negative electrode active material layer. In one or more embodiments, when the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder serves to adhere (securely or substantially adhere) the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may include (e.g., may be selected from) a styrene-butadiene rubber, an acrylated styrene-butadiene rubber, an acrylonitrile-butadiene rubber, an acrylic rubber, a butyl rubber, a fluororubber, and/or a combination thereof. The polymer resin binder may include (e.g., may be selected) from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and/or a combination thereof.

When a water-soluble binder is utilized as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and utilized. The alkali metal may be Na, K, or Li. An amount of the thickener utilized may be about 0.1 parts by weight to about 3 parts by weight based on 100 parts by weight of the negative electrode active material.

The conductive material is included to provide electrode conductivity and any electrically conductive material may be utilized as a conductive material unless it causes a chemical change. Examples of the conductive material include a carbon-based material such as natural graphite, artificial graphite, carbon black, acetylene black, ketjen black, a carbon fiber, carbon nanotube, and/or the like; a metal-based material of a metal powder or a metal fiber including copper, nickel, aluminum, silver, and/or the like; a conductive polymer such as a polyphenylene derivative; or a mixture thereof.

The negative electrode current collector may include one of (e.g., one selected from) a copper foil, a nickel foil, a stainless-steel foil, a titanium foil, a nickel foam, a copper foam, a polymer substrate coated with a conductive metal, and/or a combination thereof.

### Electrolyte

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. Examples of the ester-based solvent include methyl acetate, ethyl acetate, n-propyl acetate, dimethyl acetate, methyl propionate, ethyl propionate, y-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like and the ketone-based solvent may be cyclohexanone, and/or the like. In one or more embodiments, the alcohol-based solvent may be ethyl alcohol, isopropyl alcohol, etc. and the aprotic solvent may be nitriles such as R—CN, where R is a C2 to C20 linear, branched, or cyclic hydrocarbon group and may include a double bond, an aromatic ring, or an ether bond, amides such as dimethylformamide, dioxolanes such as 1,3-dioxolane, sulfolanes, and/or the like.

The non-aqueous organic solvent may be utilized alone or in a mixture. When the organic solvent is utilized in a mixture, the mixture ratio may be controlled or selected in accordance with a desirable battery performance.

In one or more embodiments, in the case of the carbonate-based solvent, a mixture of a cyclic carbonate and a chain carbonate may be utilized. In this case, when the cyclic carbonate and the chain carbonate are mixed in a volume ratio of about 1:1 to about 1:9, the electrolyte solution may exhibit excellent or suitable performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

The aromatic hydrocarbon-based solvent may be an aromatic hydrocarbon-based compound represented by Chemical Formula I.

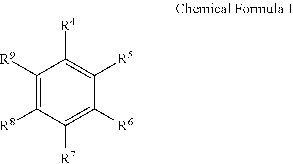

In Chemical Formula I, R⁴ to R⁹ may each independently be the same or different and may include (e.g., may be selected from) hydrogen, a halogen, a C1 to C10 alkyl group, a haloalkyl group, and/or a combination thereof.

Specific examples of the aromatic hydrocarbon-based solvent may be (e.g., may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof.

The electrolyte solution may further include vinylene carbonate or an ethylene carbonate-based compound represented by Chemical Formula II in order to improve life-cycle characteristics of a battery.

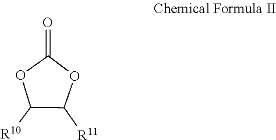

In Chemical Formula II, R¹⁰ and R¹¹ may each independently be the same or different and may include (e.g., may be selected from) hydrogen, a halogen, a cyano group, a nitro group, and/or fluorinated C1 to C5 alkyl group, provided that at least one of R¹⁰ and R¹¹ is a halogen, a cyano group, a nitro group, and fluorinated C1 to C5 alkyl group, and R¹⁰ and R¹¹ are not concurrently (e.g., simultaneously) hydrogen.

Examples of the ethylene-based carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving life-cycle characteristics may be utilized within an appropriate or suitable range.

The lithium salt dissolved in the non-organic solvent supplies lithium ions in a battery, enables a basic operation of a rechargeable lithium battery, and improves transportation of the lithium ions between positive and negative electrodes.

Examples of the lithium salt include at least one supporting salt of (e.g., selected from) LiPF₆, LiBF₄, LiSbF₆, LiAsF₆, LIN(SO₂C₂F₅)₂, Li(CF₃SO₂)₂N, LIN(SO₃C₂F₅)₂, Li(FSO₂)₂N (lithium bis(fluorosulfonyl)imide): LiFSI), LiC₄F₉SO₃, LiCIO₄, LiAIO₂, LiAICI₄, LIPO₂F₂, LIN(CₓF₂ₓ₊₁SO₂)(C_{y}F_{2y+1}SO₂), wherein x and y are natural numbers, for example, an integer in a range of 1 to 20, lithium difluoro(bisoxolato) phosphate, LiCI, Lil, LIB(C₂O₄)₂ (lithium bis(oxalato) borate, LiBOB), and/or lithium difluoro(oxalato)borate (LiDFOB).

The lithium salt may be utilized in a concentration in a range of about 0.1 M to about 2.0 M. When the lithium salt is included at the above concentration range, an electrolyte may have excellent or suitable performance and lithium ion mobility due to optimal or suitable electrolyte conductivity and viscosity.

### Separator

The separator 113 separates a positive electrode 114 and a negative electrode 112 and provides a transporting passage for lithium ions and may be any generally-utilized separator in a lithium ion battery. In other words, it may have low resistance to ion transport and excellent or suitable impregnation for an electrolyte solution. For example, separator may include (e.g., may be selected from) a glass fiber, polyester, Teflon, polyethylene, polypropylene, polytetrafluoroethylene, or a combination thereof. It may have a form of a non-woven fabric or a woven fabric. For example, in a lithium ion battery, a polyolefin-based polymer separator such as polyethylene and polypropylene is mainly utilized. In order to ensure the heat resistance or mechanical strength, a coated separator including a ceramic component or a polymer material may be utilized. Optionally, it may have a single-layered or multi-layered structure.

Rechargeable lithium batteries may be classified as lithium ion batteries, lithium ion polymer batteries, and lithium polymer batteries according to the presence of a separator and the type or kind of electrolyte utilized therein. The rechargeable lithium batteries may have a variety of shapes and sizes, and shape examples include cylindrical, prismatic, coin, and/or pouch-type or kind batteries, and size examples may include (e.g., be) thin film batteries and/or rather bulky in size batteries. Structures and manufacturing methods for lithium ion batteries pertaining to this disclosure are generally available or suitable in the art.

Hereinafter, examples of the present disclosure and comparative examples are described. It is to be understood, however, that the examples are for the purpose of illustration and are not to be construed as limiting the present disclosure.

### Preparation Example 1: Preparation of Positive Temperature Coefficient Resin Composition

As a positive temperature coefficient resin, LDPE resin particles with a weight average molecular weight (Mw) of 120,000 g/mol and a D50 particle diameter of 1 μm were utilized.

60 wt % of the LDPE resin particles as the positive temperature coefficient resin, 30 wt % of carbon black particles with a D50 particle diameter of 30 nm as a first conductive material, and 10 wt % of polyacrylic acid as a first binder were mixed in an aqueous solvent, preparing a positive temperature coefficient resin composition.

### Preparation Example 2: Preparation of Lithium Transition Metal Phosphate Composition

As a lithium transition metal phosphate, LiFePO₄ with a D50 particle diameter of 0.5 to 0.7 μm was utilized.

90 wt % of LifePO₄ as the lithium transition metal phosphate and 5 wt % of carbon black particles with a D50 particle diameter of 30 nm as a second conductive material, and 5 wt % of polyvinylidene fluoride as a second binder were mixed in an N-methylpyrrolidone solvent, thereby preparing a lithium transition metal phosphate composition.

### Preparation Example 3: Preparation of Positive Electrode Active Material Slurry

As a positive electrode active material, LiCoO₂ with a D50 particle diameter of 17 μm was utilized.

95 wt % of LiCoO₂ as the positive electrode active material, 3 wt % of polyvinylidene fluoride as a third binder, and 2 wt % of ketjen black as a third conductive material were mixed in an N-methylpyrrolidone solvent, thereby preparing positive electrode active material slurry.

### Comparative Example 1: Manufacture of Positive Electrode Having Structure of Current Collector/Functional Layer (Preparation Example 1)/Active Material Layer (Preparation Example 3) and Rechargeable Lithium Battery Including the Same

### (1) Manufacture of Positive Electrode

The positive temperature coefficient resin composition of Preparation Example 1 was coated on one surface of an aluminum current collector and dried to form a 10 μm-thick functional layer. On the functional layer, the positive electrode active material slurry of Preparation Example 3 was coated and dried to form a 150 μm-thick positive electrode active material layer.

### (2) Manufacture of Negative Electrode

97.3 wt % of graphite as a negative electrode active material, 0.5 wt % of denka black, 0.9 wt % of carboxylmethyl cellulose, and 1.3 wt % of a styrenebutadiene rubber were mixed in an aqueous solvent, thereby preparing a negative electrode active material slurry. This slurry was coated on a copper foil and dried to form a negative electrode active material layer.

### (3) Manufacture of Battery Cells

The manufactured positive electrode, a separator with a polyethylene/polypropylene multi-layer structure, and the manufactured negative electrode were sequentially stacked to manufacture a pouch-type or kind cell, and an electrolyte solution prepared by mixing ethylene carbonate and diethyl carbonate in a volume ratio of 50:50 and dissolving 1.0 M LiPF₆ lithium salt therein were added to the pouch-type or kind cell, thereby manufacturing a rechargeable lithium battery cell.

### Examples 1 to 5: Manufacture of Positive Electrode Having Structure of Current Collector/Functional Layer (Preparation Example 1)/Second Functional Layer (Preparation Example 2)/Active Material Layer (Preparation Example 3) and Rechargeable Lithium Battery Cells Including the Same

On one surface of an aluminum current collector, the positive temperature coefficient resin composition of Preparation Example 1 was coated and dried to form a first functional layer. On the first functional layer, the lithium transition metal phosphate composition of Preparation Example 2 was coated and dried to form a second functional layer. On the second functional layer, the positive electrode active material slurry of Preparation Example 3 was coated and dried to form a 150 μm-thick positive electrode active material layer. Herein, each positive electrode of Examples 1 to 5 was manufactured by changing a thickness ratio of the first functional layer and the second functional layer as shown in Table 2. Each rechargeable lithium battery cell of Examples 1 to 5 was manufactured in substantially the same manner as in Comparative Example 1 except that the positive electrodes of Examples 1 to 5 were respectively utilized.

### Example 6: Manufacture of Positive Electrode Having Structure of Current Collector/First Functional Layer (Preparation Example 2)/Second Functional Layer (Preparation Example 1)/Active Material Layer (Preparation Example 3) and Rechargeable Lithium Battery Cells Including the Same

On one surface of an aluminum current collector, the lithium transition metal phosphate composition of Preparation Example 2 was coated and dried to form a 3 μm-thick first functional layer. On the first functional layer, the positive temperature coefficient resin composition of Preparation Example 1 was coated and dried to form a 3 μm-thick second functional layer. On the second functional layer, the positive electrode active material slurry of Preparation Example 3 was coated and dried to form a 150 μm-thick positive electrode active material layer. A rechargeable lithium battery cell of Example 6 was manufactured in substantially the same manner as in Comparative Example 1 except that the obtained positive electrode was utilized.

TABLE 2

| | Components for each functional layer | | Thickness (μm) |
|---|---|---|---|
| Comparative | functional layer | PTC (LDPE) | 10 |
| Example 1 | (monolayer) | | |
| Example 1 | first functional layer | PTC (LDPE) | 1 |
| | second functional layer | LFP | 2 |
| Example 2 | first functional layer | PTC (LDPE) | 1 |
| | second functional layer | LFP | 5 |
| Example 3 | first functional layer | PTC (LDPE) | 1 |
| | second functional layer | LFP | 9 |
| Example 4 | first functional layer | PTC (LDPE) | 3 |
| | second functional layer | LFP | 5 |
| Example 5 | first functional layer | PTC (LDPE) | 5 |
| | second functional layer | LFP | 5 |
| Example 6 | first functional layer | LFP | 3 |
| | second functional layer | PTC (LDPE) | 3 |

### Evaluation Example 1: Evaluation of Positive Electrode

### (1) Resistance Increase Rate at High Temperature

The positive electrodes of Examples 1 to 6 and Comparative Example 1 were respectively utilized to manufacture a symmetry cell and after installing a temperature sensor and a resistance meter thereon, put in a temperature-varying chamber for evaluation. The rechargeable lithium battery cells were measured with respect to temperature and resistance changes, while the temperature was increased at 10° C./min, to evaluate a resistance increase rate according to a temperature of each positive electrode, and the results are shown in Table 3.

### (2) Evaluation of Resistance Characteristics

The positive electrodes of Examples 1 to 6 and Comparative Example 1 were respectively mounted between two measuring pins on top and at a bottom of the sheet resistance meter, and then, a current of 10 mA was applied thereto to measure resistance, and the results are shown in Table 3.

### (3) Adhesion Force

The positive electrodes of Examples 1 to 6 and Comparative Example 1 were respectively cut into a size of 25 mm×100 mm to prepare specimens, and the specimens were measured with respect to 180° peel strength (unit: N/m) by utilizing a peel strength meter at a peeling rate of 100 mm/min, a measurement distance of 25 mm, and 25° C., and the results are shown in Table 3.

TABLE 3

| | Positive electrode | Positive | Positive |
|---|---|---|---|
| | resistance | electrode | electrode |
| | increase rate @ | resistance | adhesion force |
| | 120° C. (%) | (%) | (gf/mm) |
| Comparative Example 1 | 63 | 110 | 0.31 |
| Example 1 | 114 | 30 | 0.71 |
| Example 2 | 105 | 60 | 0.64 |
| Example 3 | 109 | 105 | 0.59 |
| Example 4 | 188 | 75 | 1.31 |
| Example 5 | 181 | 90 | 1.33 |
| Example 6 | 174 | 55 | 0.53 |

Referring to Table 3, the positive electrodes of Examples 1 to 6 were not only suppressed or reduced from the resistance increase at a high temperature but also exhibited excellent or suitable adhesion forces between current collector and functional layer, compared with the positive electrode of Comparative Example 1.

### Evaluation Example 2: Evaluation of Rechargeable Lithium Battery Cells

The rechargeable lithium battery cells of Examples 1 to 6 and Comparative Example 1 were constant current-charged at a current rate of 0.5 C to a voltage of 4.4 V (vs. Li) and cut off at a current rate of 0.05 C, while 4.4 V was maintained in a constant voltage mode at 25° C. Subsequently, the cells were constant current-discharged to a voltage of 2.8 V (vs. Li) at a rate of 1.0 C. This charge and discharge cycle was 150 times repeated. Between all the charge and discharge cycles, each charge and discharge was paused for 10 minutes.

The rechargeable lithium battery cells were evaluated with respect to cycle-life characteristics by utilizing capacity retention according to Equation 1, and the results are shown in Table 4.

$$Capacity \text{} retention = [ \text{} discharge capacity at {1 \; 50}^{th} cycle / discharge at {1}^{st} cycle ] \times 100 \qquad Equation 1$$

TABLE 4

| | Battery capacity retention @ 25° C. (%) |
|---|---|
| Comparative Example 1 | 83 |
| Example 1 | 93 |
| Example 2 | 91 |
| Example 3 | 84 |
| Example 4 | 90 |
| Example 5 | 88 |
| Example 6 | 91 |

Referring to Table 3, the rechargeable lithium battery cells of Examples 1 to 6 also exhibited excellent or suitable cycle-life characteristics at room temperature, compared with the rechargeable lithium battery cell of Comparative Example 1.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While certain embodiments of the present disclosure have been illustrated and described, it is understood by those of ordinary skill in the art that certain modifications and changes can be made to the described embodiments without departing from the spirit and scope of the present disclosure as defined by the following claims, and equivalents thereof.

### REFERENCE NUMERALS

| | |
|---|---|
| 10: current collector | 20: first functional layer |
| 30: third functional layer | 40: active material layer |
| 100: rechargeable lithium battery | |
| 112: negative electrode | |
| 113: separator | 114: positive electrode |
| 120: battery case | 140: sealing member |

What is claimed is:

1. An electrode for a rechargeable lithium battery, the electrode comprising:
a current collector;
an active material layer on the current collector; and
a functional layer between the current collector and the active material layer,
wherein the functional layer comprises a first functional layer and a second functional layer,
the first functional layer comprises a positive temperature coefficient (PTC) resin, and
the second functional layer comprises a lithium transition metal phosphate.

2. The electrode of claim 1, wherein
the first functional layer is in contact with the current collector and the second functional layer is in contact with the active material layer.

3. The electrode of claim 1, wherein
a thickness ratio of the first functional layer and the second functional layer is about 3:7 to about 7:3.

4. The electrode of claim 1, wherein
a thickness ratio of an entire functional layer comprising the first functional layer and the second functional layer; and the active material layer is about 1:1 to about 1:1,000.

5. The electrode of claim 1, wherein
the positive temperature coefficient resin expands in a temperature range of about 60° C. to about 200° C.

6. The electrode of claim 5, wherein
the positive temperature coefficient resin comprises high density polyethylene (HDPE), polypropylene (PP), low density polyethylene (LDPE), polystyrene (PS), polytetrafluoroethylene (PTFE), polyvinyl chloride (PVC), or a combination thereof.

7. The electrode of claim 1, wherein
the first functional layer further comprises a first conductive material, a first binder, or a combination thereof.

8. The electrode of claim 7, wherein
a D50 particle diameter of the first conductive material is about 1 nm to about 100 nm.

9. The electrode of claim 7, wherein
the first binder comprises a polyvinylidene fluoride-based binder, a polyamide-based binder, or a combination thereof.

10. The electrode of claim 7, wherein
based on 100 wt % of a total amount of the first functional layer, the positive temperature coefficient resin is included in an amount of about 5 wt % to about 80 wt %, the first conductive material is included in an amount of about 0.1 wt % to about 50 wt %, and the first binder is included in an amount of about 0.1 wt % to about 50 wt %.

11. The electrode of claim 1, wherein
the lithium transition metal phosphate comprises a compound represented by Chemical Formula 1, a compound represented by Chemical Formula 2, or a combination thereof: 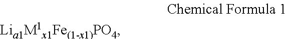
wherein, in Chemical Formula 1, 0.90≤a1≤1.5, 0≤x1≤0.4, and M¹ is Mg, Co, Ni or a combination thereof, and 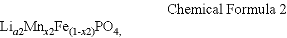
wherein, in Chemical Formula 2, 0.90≤a2≤1.5 and 0.1≤x2≤1.

12. The electrode of claim 1, wherein
a D50 particle diameter of the lithium transition metal phosphate is less than or equal to about 2 μm and greater than 0 μm.

13. The electrode of claim 1, wherein
the second functional layer further comprises a second conductive material, a second binder, or a combination thereof.

14. The electrode of claim 13, wherein
a D50 particle diameter of the second conductive material is about 1 nm to about 100 nm.

15. The electrode of claim 13, wherein
the second binder comprises a polyvinyl chloride-based binder.

16. The electrode of claim 13, wherein
based on 100 wt % of a total amount of the second functional layer, the second functional layer comprises about 50 wt % to about 99 wt % of the lithium transition metal phosphate, about 0.5 wt % to about 10 wt % of the second conductive material, and about 0.5 to about 20 wt % of the second binder.

17. The electrode of claim 1, wherein
the electrode is a positive electrode, and the active material layer comprises a positive electrode active material represented by Chemical Formula 3: 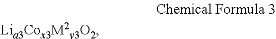
and
wherein, in Chemical Formula 3, 0.9≤a3≤1.8, 0.3≤x3≤0.98, 0.01≤y3≤0.69, and M² comprises Al, Mn, B, Ce, Cr, F, Mg, Mo, Nb, P, S, Si, Sr, Ti, V, W, Zr, or a combination thereof.

18. The electrode of claim 1, wherein
the active material layer further comprises a third conductive material, a third binder, or a combination thereof.

19. The electrode of claim 18, wherein
based on 100 wt % of a total amount of the active material layer, the active material layer comprises about 85 wt % to about 98 wt % of an electrode active material, about 1 wt % to about 10 wt % of the third conductive material, and about 1 wt % to about 10 wt % the third binder.

20. A rechargeable lithium battery, comprising:
a positive electrode;
a negative electrode; and
an electrolyte,
wherein at least one of the positive electrode or the negative electrode is the electrode of claim 1.
